(19) United States
(12) Patent Application Publication
(10) Pub. No.: US 2026/0343109 A1
(43) Pub. Date: Oct. 29, 2026

(54) METHOD FOR PROCESSING AND STORING IMAGE DATA, AND CAMERA SYSTEM

(71) Applicant: Arnold & Richter Cine Technik GmbH & Co. Betriebs KG, München (DE)

(72) Inventors: Tamara SEYBOLD, München (DE); Thomas EINGARTNER, München (DE); Harald BRENDEL, München (DE)

(21) Appl. No.: 19/273,486

(22) Filed: Jul. 18, 2025

(30) Foreign Application Priority Data
Jul. 19, 2024 (DE) 10 2024 120 612.8

(51) Int. Cl. H04N 23/951; H04N 25/13; H04N 25/618

(52) U.S. Cl. CPC H04N 23/951; H04N 25/135; H04N 25/618

(57) ABSTRACT

In a method for processing and storing image data, a provision of sensor image data of an image sensor of a camera takes place, wherein the sensor image data have a first spatial resolution and comprise at least three color channels, wherein the sensor image data comprise, for each pixel, only one signal value from one of the at least three color channels of the sensor image data. Based on the sensor image data, color image data are generated that correspond to a second spatial resolution and that comprise at least three color channels, wherein the color image data comprise, for each pixel, at least three signal values, wherein the second spatial resolution is lower than the first spatial resolution. Based on the sensor image data, supplementary image data are further generated that correspond to a third spatial resolution and that comprise only a single color channel, wherein the supplementary image data comprise only one signal value for each pixel. The color image data and the supplementary image data are stored such that the color image data can be accessed independently of the supplementary image data.

The invention relates to a method for processing and storing image data based on sensor image data of an image sensor of a camera. The invention further relates to a corresponding camera system.

Conventional or electronic motion picture cameras are used in cinematographic productions (also designated as film productions). A digital motion picture camera comprises an electronic image sensor for generating sensor image data and a signal output for outputting the sensor image data and/or a memory for storing the sensor image data during a shooting of a motion picture scene. The image sensor has a large number of light-sensitive sensor elements, for example as a two-dimensional matrix. The image sensor may have a color filter matrix (color filter array, CFA) comprising at least three different spectral filters in a repeating pattern, for example according to the so-called Bayer pattern (RGGB arrangement).

The sensor image data generated correspond to electrical image signals of the light-sensitive sensor elements. The sensor elements generate the image signals in dependence on incident light. The motion picture camera may have an integrated objective (lens), which images a scene onto the image sensor, or a lens mount for fastening an interchangeable lens. The camera may record a motion picture sequence that consists of frames, wherein the frames may, for example, be respective full images or half-images that only contain a complete image content together with other half-images. The image data of each frame may form an image data set.

Apart from an amplification and digitization, the image signals of the light-sensitive sensor elements may generally be recorded as sensor image data without further processing. However, it is also possible that certain corrections are made to the sensor image data, for example to compensate for physical errors of the image sensor, such as gain inhomogeneities or offset inhomogeneities or completely defective sensor elements.

The sensor image data may further be processed such that a color image sequence is produced that may be displayed on a suitable display device (for example, a monitor, viewfinder) so that a recorded motion picture scene may be viewed substantially correctly there. Since, when using an image sensor comprising a color filter array, only a single signal value (mosaic image data) is present for each pixel (image location) and at least three signal values per pixel are, however, required for the display of a color image, a supplementation of the sensor image data by interpolation is required (so-called demosaicing). Such an interpolation method may already be carried out in the camera before the recording, i.e. before the output or storing of the sensor image data. In this case, at least three signal values per pixel are therefore already output or stored.

Large amounts of data are produced when using high-resolution image sensors. For this reason, the sensor image data (mosaic image data or interpolated image data) are often already compressed in the camera before the output or storage. Here, an attempt is typically made to identify redundant information and not to record it. It is also possible to take human vision into account during the data compression and to omit those image contents during the recording which the subsequent viewer will not be able to perceive.

Due to the use of a color filter array, color information may indeed be generated; however, a spectrally dependent limitation of the resolution of the image sensor and thus of the generated sensor image data hereby results. In order to achieve a sufficient or desired resolution in the interpolated image data, a corresponding oversampling in the image sensor is required. However, large amounts of image data are thereby produced. The smallest effort is produced for the recording in the camera if the sensor image data are output or stored without further processing, i.e. as raw image data. A disadvantage of such raw image data is that no viewable color image is produced at the same time as the recording of a scene, for example, for viewing on a viewfinder or monitor. If the sensor image data are interpolated before the recording, a viewable image (RGB image) is indeed produced. However, on the one hand, this requires a considerable processing effort; on the other hand, the amount of image data that then has to be recorded (output or stored) is multiplied. If a data compression is used to reduce the amount of image data, other disadvantages again arise. If, for example, raw image data are compressed, a correlation of the different color channels must be assumed so that inaccuracies are introduced. If, on the other hand, interpolated image data are compressed, the efficiency is lower since the amount of data has already been multiplied before the compression. It may further be necessary to impart certain color space shifts to the image data in order to improve the interpolation result. These shifts may possibly no longer be reversed after the decompression (decoding) of the image data.

It is an object of the invention to provide a method for processing and storing image data that avoids or reduced the aforementioned disadvantages.

The object is satisfied by a method having the features of claim 1.

The method for processing and storing image data comprises the steps:
providing sensor image data of an image sensor of a camera, wherein the sensor image data have a first spatial resolution and comprise at least three color channels, wherein the first spatial resolution corresponds to a number of first pixels and the sensor image data comprise, for each of the first pixels, only one signal value from one of the at least three color channels of the sensor image data;
based on the sensor image data, generating color image data that correspond to a second spatial resolution and that comprise at least three color channels, wherein the second spatial resolution corresponds to a number of second pixels and the color image data comprise, for each of the second pixels, at least three signal values in accordance with the at least three color channels of the color image data, wherein the second spatial resolution of the color image data is lower than the first spatial resolution of the sensor image data;
based on the sensor image data, generating supplementary image data that correspond to a third spatial resolution and that comprise only a single color channel, wherein the third spatial resolution corresponds to a number of third pixels and the supplementary image data comprise, for each of the third pixels, only one signal value in accordance with the single color channel of the supplementary image data; and
storing the color image data and the supplementary image data such that the color image data may be accessed independently of the supplementary image data.

The method is based on sensor image data that are, for example, generated by an image sensor of a camera during the execution of the method or that have already been generated at an earlier point in time. The method may thus be carried out largely within a camera or also partly or completely in a data processing device that is separate from the camera (for example, a personal computer, workstation, cloud server). If the method is carried out within the camera, the camera may have a signal processing device for this purpose, for example a microprocessor, a central processing unit (CPU), a graphics processing unit (GPU), an application-specific integrated circuit (ASIC) and/or a field programmable gate array (FPGA). The sensor image data may in particular be RGB image data.

The generated color image data allow the image content to be viewed on a standard display device (for example, a camera viewfinder, monitor). Thus, the shooting of a motion picture scene may, for example, be monitored during the recording without a particular additional computing effort. Therefore, no parallel image processing path is required in the camera for this purpose. Furthermore, a control image corresponding to the color image data may be distributed immediately, for example, to be able to start the so-called post-production (rough cut, special effects, etc.) immediately after the recording of a motion picture scene. The color image data may also in particular be RGB image data. However, due to the reduced resolution of the color image data, said color image data require relatively little bandwidth, computing capacity and memory space. The color image data may thus also be distributed easily and quickly on a cloud basis. The color information contained in the color image data also allow conclusions to be drawn about a correlation of the color channels, which in turn may be used to efficiently compress the image data before the recording.

In combination with the color image data, the generated supplementary image data enable a subsequent processing of the color image data in terms of an increase of the information content, in particular to increase the resolution or to correct brightness developments. Such a subsequent processing of the color image data may take place at a later point in time and in particular outside the camera that generates the sensor image data, for example, by a data processing device that is separate from the camera (for example, a personal computer, workstation, cloud server).

The color image data and the supplementary image data are stored such that the color image data may be accessed independently of the supplementary image data. Thus, the color image data may be used or further processed without necessarily accessing the supplementary image data. The color image data and the supplementary image data may be output and/or stored separately from one another and/or offset in time from one another. The color image data and the supplementary image data may be stored, for example, in a data memory of the camera or in a recorder coupled to the camera in a wired manner or in a data memory wirelessly coupled to the camera. The same applies to the supplementary image data.

Since the color image data and the supplementary image data may be further processed, in particular stored and/or output, independently of one another after they have been generated, the sequences of a film production are simplified. With the color image data, the first processing steps, for which the highest quality level of the film material is typically not yet required, may be carried out quickly. Due to the segmenting of the sensor image data into the color image data and the supplementary image data, particularly suitable and thus efficient compression methods may also be used in each case.

The respective spatial resolution of the various mentioned image data that is mentioned in the present context generally corresponds to the number of picture elements (pixels) of a respective image data set that may be associated with a predetermined spatial arrangement, in particular along columns and rows. The image data mentioned comprise, for each of the pixels, one or more image signal values that correspond to a brightness value and together represent an image content. These image signal values may be associated with different color channels and are therefore referred to as signal values in the present context for the sake of simplicity. In relation to an image sensor that has generated said sensor image data, said first spatial resolution may in particular correspond to the physical (native) resolution of the image sensor in accordance with the arrangement of light-sensitive sensor elements if the image sensor is provided with a color filter array. For example, the sensor image data may have a so-called 4K resolution (approximately 4096 pixels in the horizontal direction, i.e. 4096 columns), 6K resolution (approximately 6144 columns) or 8K resolution (approximately 8192 columns), each in an aspect ratio of, for example, 4:3 or 16:9 (i.e., for example, 2304 lines with 4096 columns).

The color channels of the sensor image data mentioned in the present context correspond to the possible different color information at the location of the individual pixels. To be able to reproduce a color image, at least three color channels are generally required, for example red, green and blue. An image sensor that is provided with a color filter array that comprises three different color filters generates sensor image data with three color channels, wherein the sensor image data comprise, for each pixel, only one signal value, corresponding to the color filter at the location of the respective pixel or (at sensor level) at the location of the respective sensor element. The same applies to said color channels of the color image data or to the single color channel of the supplementary image data. However, this does not mean that each color channel of the sensor image data must be assigned the same number of pixels. Instead, the relative frequency of the respective spectral filters of the color filter array may differ, for example, to achieve a better approximation to human vision. Accordingly, the sensor image data for one color channel (in particular the green color channel) may comprise more signal values than for the other color channels (in particular the red color channel and the blue color channel).

If the sensor image data comprise signal values of different colors, each color is assigned exactly one color channel in the present context, i.e. a single color is regarded and considered as a single color channel. This in particular also applies to the color green, even if more signal values are available for this color than for other colors.

Insofar as the generated color image data “correspond to a second spatial resolution”, this means in the present context that the color image data either have the second spatial resolution as visually observable image data or that the signal values of the color image data are associated with respective pixel positions in accordance with the second spatial resolution despite a filtering or segmenting according to spatial frequencies. The same applies to the supplementary image data that “correspond to a third spatial resolution”.

Further advantageous embodiments are explained below.

In some embodiments, the method may further comprise the step of generating the sensor image data by means of an image sensor of a camera, said image sensor, as already explained, comprising a plurality of light-sensitive sensor elements that are arranged in columns and rows. The image sensor may, for example, be made of silicon in CMOS or CCD technology.

In some embodiments, the sensor image data may comprise signal values of a first color, signal values of a second color, and signal values of a third color, wherein, for a respective image data set of the sensor image data, the number of signal values of the first color is greater than the number of signal values of the second color and than the number of signal values of the third color. A color channel corresponding to this first color is also referred to below as the first color channel for some embodiments. As already explained, the image sensor may comprise a color filter array, in particular according to the so-called Bayer pattern, so that the sensor image data generally comprise twice as many green signal values as red signal values or blue signal values. According to the Bayer pattern, of a respective four sensor cells arranged in two rows and two columns, two sensor cells arranged diagonally to one another are provided with a green-transmitting color filter and, of the two remaining sensor cells, one is provided with a red-transmitting color filter and the other with a blue-transmitting color filter.

In some embodiments, the sensor image data may comprise more signal values for one of the at least three color channels than for every further one of the at least three color channels, wherein the single color channel of the supplementary image data corresponds to this one color channel of the sensor image data. It may in particular be green color channel in this case.

In some embodiments, the sensor image data may be associated with a motion picture sequence, wherein color image data already generated during a generating of further sensor image data of the motion picture sequence (i.e. color image data generated based on already previously generated sensor image data) are displayed on a display device of the camera, for example on a monitor or a viewfinder. The method thus enables a control observation of a recorded motion picture scene with little additional computing effort and a low latency.

In some embodiments, the at least three different color channels of the color image data may correspond to or be derived from the at least three different color channels of the sensor image data. In particular, the number of color channels of the color image data may be identical to the number of color channels of the sensor image data.

Insofar as the at least three different color channels of the color image data “correspond to or are derived from” the at least three different color channels of the sensor image data, this means in the present context that the color channels of the color image data each represent identical color information to the color channels of the sensor image data; or that, by mutually offsetting the color channels of the sensor image data, in particular by forming linear combinations, the color channels of the color image data comprise a modified color information. In the latter case, the offsetting of the color channels of the sensor image data may, however, comprise completely reversible operations. For example, one or more green signal values may be subtracted from a respective red or blue signal value of the sensor image data to arrive at a derived color channel of the color image data. In this context, the color channels of the color image data may also be referred to as color planes.

The same also applies to the supplementary image data, i.e. said single color channel of the supplementary image data may correspond to one of the at least three different color channels of the sensor image data or be derived therefrom.

In some embodiments, the third spatial resolution of the supplementary image data may be higher than the second spatial resolution of the color image data. The supplementary image data may hereby be used particularly effectively for a subsequent processing of the color image data. However, in some embodiments, the third spatial resolution of the supplementary image data may also be lower than the second spatial resolution of the sensor image data, for example, if signal values for additional pixel positions must be generated for non-dyadic ratios between the first and the second spatial resolution, as will be explained below.

In some embodiments, the third spatial resolution of the supplementary image data may be equal to or less than the first spatial resolution of the sensor image data. In other words, the third spatial resolution of the generated supplementary image data may correspond to an intermediate value between the second spatial resolution of the color image data and the first spatial resolution of the sensor image data, or may match the first spatial resolution of the sensor image data.

In some embodiments, the pixel positions of the second pixels (in particular the pixel positions of all the second pixels) of the color image data in accordance with the second spatial resolution may correspond to pixel positions of the first pixels of the sensor image data in accordance with the first spatial resolution and/or the pixel positions of the third pixels (in particular the pixel positions of all the third pixels) of the supplementary image data in accordance with the third spatial resolution may correspond to pixel positions of the first pixels of the sensor image data in accordance with the first spatial resolution.

In some embodiments, the color image data may correspond to low spatial frequencies of the sensor image data, wherein the supplementary image data correspond to high spatial frequencies of the sensor image data. In particular, some or all of the color image data may be spatial frequency values that correspond to low spatial frequencies of the sensor image data, wherein all of the supplementary image data are spatial frequency values that correspond to high spatial frequencies of the sensor image data. The color image data thus represent large-scale changes to the signal values, and thus to the image content of the respective color channel, and the supplementary image data represent small-scale changes to the signal values and thus to the image content of said single color channel. The generated color image data may here contain information about signal values of first pixels of the sensor image data in the environment of a considered pixel in accordance with the respective color channel and the color image data differ in this regard, for example, from signal values that are determined by a pure subsampling of the sensor image data. The information on high spatial frequencies, said information contained in the supplementary image data, may be used in combination with the color image data for a subsequent processing of the color image data.

In some embodiments, the signal values in accordance with the single color channel of the supplementary image data and the signal values in accordance with that color channel of the color image data which corresponds to the single color channel of the supplementary image data may together substantially comprise the information content of the color channel of the sensor image data that corresponds to the single color channel of the supplementary image data. Thus, the respective color channel of the sensor image data may substantially be completely reconstructed. The restriction “substantially” here means that, depending on the type of the division and subsequent combination, a certain loss of information, which is in particular due to mathematical reasons, may occur, for example, in the case of the aforementioned division into low and high spatial frequencies and their subsequent recombination.

In some embodiments, the step of generating the color image data based on the sensor image data comprises the following processing steps:
interpolating the sensor image data in order to determine at least two further signal values for each of the first pixels so that a respective signal value is present for each of the first pixels and for each of the at least three color channels of the sensor image data;
for each of the at least three color channels of the sensor image data, transforming the signal values including the interpolated signal values into spatial frequency values that correspond to low and high spatial frequencies; and
determining the color image data for each of the at least three color channels of the color image data by selecting spatial frequency values that correspond to low spatial frequencies;
   wherein the step of generating the supplementary image data based on the sensor image data comprises the following processing step:
determining the supplementary image data for the single color channel of the supplementary image data by selecting spatial frequency values that correspond to high spatial frequencies.

In such embodiments, the sensor image data are completely interpolated so that three signal values are present for all of the first pixels in accordance with the (higher) first spatial resolution. For this purpose, the determined two further signal values may correspond to the color channels for which no signal value is yet present for the respective first pixel. The interpolation may be carried out according to a customary process for converting mosaic image data into RGB image data, as initially explained. In the present context, the interpolation may comprise a spatial filtering (within the respective color channel or with an additional taking into account of signal values also of other color channels). The signal values of the sensor image data (original signal values and interpolated signal values) are segmented into different spatial frequencies for each of the at least three color channels of the sensor image data by a transformation. The transformed signal values thus form spatial frequency values that represent different spatial frequencies of the image information, namely low and high spatial frequencies. The transformation may, for example, be performed directly or indirectly by a spatial low-pass filtering and a spatial high-pass filtering, or generally by a spatial band-pass filtering. Low spatial frequencies are selected from the image information thus separated according to spatial frequencies, for example, by selecting the spatial frequency values associated with the low spatial frequencies after their generation or directly by the transformation or filtering carried out (corresponding to a low-pass filter). The color image data of the (lower) second spatial resolution may hereby be determined for each color channel. On the other hand, the supplementary image data are determined by selecting high spatial frequencies of the transformed signal values only for the single color channel of the supplementary image data; this may again take place by selecting the spatial frequency values associated with the high spatial frequencies after their generation or directly by the transformation or filtering carried out (corresponding to a high-pass filter). However, the spatial frequency values or transformed signal values corresponding to the high spatial frequencies are discarded for the further color channels (i.e. for the color channels that do not correspond to the single color channel of the supplementary image data).

The “high” spatial frequencies and “low” spatial frequencies are to be understood as relative specifications in the present context, i.e. the “high” spatial frequencies are higher than the “low” spatial frequencies. The limit between the “high” spatial frequencies and the “low” spatial frequencies may be adapted to the application, in particular to the desired second spatial resolution. For example, in the case that the first spatial resolution is 8K and the second spatial resolution is 4K, the limit for the “low” spatial frequencies must be selected lower than in the case that the first spatial resolution is 8K and the second spatial resolution is 6K.

Said transformation of the signal values into spatial frequency values may take place by a discrete wavelet transform, for example. Such a discrete wavelet transform corresponds to a filtering according to spatial frequencies within the respective color channel. This filtering may take place in a direction-dependent manner (horizontally, vertically). As a result, spatial frequency values may be obtained that are localized in the spatial space and that ultimately characterize the frequency of occurrence of different frequency ranges.

With the discrete wavelet transform, the high spatial frequencies may be attenuated by applying a spatial low-pass filtering and the low spatial frequencies may be attenuated by applying a spatial high-pass filtering. The image information respectively determined by the low-pass filtering and high-pass filtering (for example, spatial frequency values) may complement one another. Since the output values of the transformation may still be localized in the spatial space, the resolution is reduced by the respective filtering, but without losing image information overall.

As already mentioned, in particular spatial frequency values that are associated with different spatial frequencies and different directions may be generated as the output values of the discrete wavelet transform, namely:
LL spatial frequency values that correspond to a low-pass filtering in the horizontal direction and a low-pass filtering in the vertical direction;
LH spatial frequency values that correspond to a low-pass filtering in the horizontal direction and a high-pass filtering in the vertical direction;
HL spatial frequency values that correspond to a high-pass filtering in the horizontal direction and a low-pass filtering in the vertical direction; and
HH spatial frequency values that correspond to a high-pass filtering in the horizontal direction and a high-pass filtering in the vertical direction.

The use of a discrete wavelet transform thus has the advantage in the present context that the image information in accordance with the second spatial resolution is present for each color channel of the color image data. The spatial frequency values corresponding to the low spatial frequencies (in particular said LL spatial frequency values) are still localized in the spatial space, i.e. they are associated with the second pixels of the color image data, and they allow the image information in accordance with the second spatial resolution to be recognized in a visual observation. The spatial frequency values corresponding to the low spatial frequencies may therefore be integrated into the usual signal display paths and signal processing paths during the recording of a motion picture sequence without complex additional measures, for example displayed on a display device (in particular after performing a color space transformation for adaptation to the display device) and/or compressed (in particular also by means of a conventional RGB compression method).

The aforementioned step of interpolating the sensor image data and the aforementioned step of transforming the signal values may also be performed within a single computing operation at least for the color channels that do not correspond to the single color channel of the supplementary image data (in particular for the red and the blue color channel). The computing effort may hereby be simplified and accelerated.

As explained, the sensor image data may comprise more signal values for one of the at least three color channels of the sensor image data (in particular the green color channel) than for each of the further ones of the at least three color channels, wherein said single color channel of the supplementary image data may correspond to this one of the at least three color channels of the sensor image data.

Alternatively thereto, in other embodiments, the step of generating the color image data based on the sensor image data may comprise the following processing steps:
for only a first color channel of the at least three color channels of the sensor image data that corresponds to said single color channel of the supplementary image data, interpolating the sensor image data in order to determine a signal value in accordance with the first color channel for those of the first pixels for which no signal value in accordance with the first color channel is yet present;
for the first color channel of the sensor image data, transforming the signal values including the interpolated signal values into spatial frequency values that correspond to low and high spatial frequencies;
determining the color image data for a first color channel of the at least three color channels of the color image data that corresponds to the first color channel of the sensor image data by selecting spatial frequency values of the first color channel that correspond to low spatial frequencies; and
determining the color image data for the further ones of the at least three color channels of the color image data by adapting the signal values in accordance with the further ones of the at least three color channels of the sensor image data to pixel positions that correspond to the color image data of the first color channel; and
   wherein the step of generating the supplementary image data based on the sensor image data comprises the following processing step:
determining the supplementary image data for the single color channel of the supplementary image data by selecting spatial frequency values that correspond to high spatial frequencies.

In such embodiments, the sensor image data are only partly interpolated, namely only for that one of the at least three color channels of the sensor image data which corresponds to said single color channel of the supplementary image data (in particular the green color channel) so that a signal value in accordance with the first color channel is present for each of the first pixels in accordance with the (higher) first spatial resolution. This interpolation may be carried out for said first color channel in accordance with a method that is customary for converting mosaic image data into RGB image data. As already mentioned, the interpolation in the present context may comprise a spatial filtering (within the respective color channel or additionally taking into account signal values of other color channels). The signal values of the sensor image data (original signal values and interpolated signal values) of the first color channel of the sensor image data are segmented into different spatial frequencies by a transformation. The transformed signal values thus form spatial frequency values that represent different spatial frequencies of the image information, namely low and high spatial frequencies, as explained above. The transformation may, for example, be performed directly or indirectly by a spatial low-pass filtering and a spatial high-pass filtering, or generally by a spatial band-pass filtering. Low spatial frequencies are selected from the image information of the first color channel, which image information is thus separated according to spatial frequencies, for example, by selecting the spatial frequency values associated with the low spatial frequencies after their generation or directly by the transformation or filtering carried out (corresponding to a low-pass filter). The color image data of the (lower) second spatial resolution may hereby be determined for the first color channel.

For the further color channels of the color image data, the color image data are determined by adapting the signal values of the sensor image data to pixel positions that correspond to the color image data of the first color channel. For the color image data in accordance with the second spatial resolution, the signal values of the different color channels must correspond to matching pixel positions, namely the positions of said second pixels that, however, do not necessarily correspond to the positions of the first pixels of the sensor image data. The adapting of the signal values of the sensor image data therefore takes into account that, with respect to the sensor image data in accordance with the (higher) first spatial resolution, the color image data have a (lower) second spatial resolution and thus the positions of the second pixels of the color image data generally do not correspond to the positions of the first pixels of the sensor image data. The adapting of the signal values of the sensor image data may thus comprise a conversion to offset pixel positions and/or an interpolation. An interpolation to generate signal values at additional pixel positions is, for example, necessary if the first and the second spatial resolution are not in a dyadic ratio to one another (e.g. 8K to 6K or 6K to 4K).

On the other hand, the supplementary image data are selected by selecting high spatial frequencies of the transformed signal values only for the single color channel of the supplementary image data; this may again take place by selecting the spatial frequency values associated with the high spatial frequencies after their generation or directly by the transformation or filtering carried out (corresponding to a high-pass filter).

The “high” spatial frequencies and “low” spatial frequencies are to be understood as relative specifications in the present context, i.e. the “high” spatial frequencies are higher than the “low” spatial frequencies. The limit between the “high” spatial frequencies and the “low” spatial frequencies may be adapted to the application, as already explained above.

Said transformation of the signal values of the first color channel into spatial frequency values may, for example, take place by a discrete wavelet transform. As explained, such a discrete wavelet transform corresponds to a filtering according to spatial frequencies within the color channel. This filtering may take place in a direction-dependent manner (horizontally, vertically). As a result, spatial frequency values may be obtained that ultimately characterize the frequency of the occurrence of different frequency ranges. The use of a discrete wavelet transform has the advantage in the present context that the image information is present in accordance with the second spatial resolution. The spatial frequency values corresponding to the low spatial frequencies are still localized in the spatial space, i.e. they are associated with the second pixels of the color image data, and they allow the image information in accordance with the second spatial resolution to be recognized for the first color channel of the sensor image data in a visual observation. The spatial frequency values corresponding to the low spatial frequencies may therefore be integrated into the usual signal display paths and signal processing paths during the recording of a motion picture sequence without complex additional measures.

Said adapting of the signal values of the respective further color channel of the sensor image data to the pixel positions that correspond to the color image data of the first color channel may, as already mentioned, comprise a conversion to offset pixel positions (horizontally and/or vertically offset pixel positions). This may, for example, take place by a spatial filtering that takes into account signal values of the respective further color channel of the sensor image data at adjacent pixel positions and signal values of the first color channel of the sensor image data at adjacent pixel positions (original signal values or original and interpolated signal values of the first color channel). In the present context, adjacent pixel positions are to be understood as directly adjacent and indirectly adjacent pixel positions in the environment of the respective pixel under consideration, i.e. also next-but one neighbors, for example. Thus, not only signal values of the respective further color channel of the sensor image data at adjacent pixel positions are taken into account for the spatial filtering (for example by a weighted interpolation), but also signal values of the first color channel of the sensor image data (in particular of the green color channel) at adjacent pixel positions. The latter may, for example, take place by forming a gradient—in particular a signal value gradient—on which the weighting of said interpolation is based. If a gradient of signal values of the first color channel of the sensor image data is formed, this preferably takes place after said interpolation of the sensor image data of the first color channel. Said adapting of the signal values of the respective further color channel of the sensor image data to the pixel positions of the first color channel may, as already mentioned, also comprise an interpolation to additional pixel positions. This interpolation may take place in the same way as the interpolation of the sensor image data of the first color channel in accordance with a customary method and may in particular comprise a spatial filtering as explained for the conversion to offset pixel positions.

The aforementioned step of interpolating the sensor image data of the first color channel and the aforementioned step of transforming the signal values of the first color channel may also be performed within a single computing operation. The computing effort may hereby be simplified and accelerated.

In the embodiments explained above, for the step of generating the color image data, signal values of the sensor image data including interpolated signal values are transformed into spatial frequency values, and then color image data are determined by selecting spatial frequency values corresponding to low spatial frequencies. Thus, the generated color image data also include information about signal values of first pixels of the sensor image data of the respective color channel in the environment of an observed pixel, as mentioned above.

As explained, the sensor image data may comprise more signal values for one of the at least three color channels of the sensor image data (in particular the green color channel) than for each of the further ones of the at least three color channels, wherein said first color channel of the sensor image data and said single color channel of the supplementary image data may correspond to this one of the at least three color channels of the sensor image data.

In some embodiments, at least one of the following steps may be performed prior to the step of generating color image data:
correcting individual sensor image data that correspond to defective or greatly deviating sensor elements of the image sensor;
performing a non-linear transformation of the sensor image data within each of the at least three color channels of the sensor image data; or
performing a white balance between the at least three color channels of the sensor image data.

For example, the sensor image data for pixels that correspond to known defective sensor elements of the image sensor or greatly deviating sensor elements may be replaced by predetermined values or by interpolated values, in particular in accordance with a filtering of the signal values of adjacent pixels within the respective color channel. In the present context, greatly deviating sensor elements are to be understood as sensor elements whose signal values deviate particularly greatly from the signal values of adjacent sensor elements (in particular of the respective color channel), in particular by a predetermined threshold value (for example, an absolute or percentage threshold value). Such pronounced deviations may also inevitably occur and may be taken into account as predetermined deviations in this regard. For example, such pronounced deviations may occur, and be taken into account, in the case of phase detection autofocus sensor elements (PDAF).

Due to a non-linear transformation of the sensor image data within each of the at least three color channels of the sensor image data, a brightness distribution of the signal values may, for example, be modified in order to simplify subsequent signal processing steps (in particular a compression of the color image data) or to increase their efficiency. The non-linear transformation may also comprise a quantization of the sensor image data by which the bit depth of the signal values is reduced. For example, higher signal values may be quantized more strongly than (relatively) lower signal values.

A white balance may, for example, be performed by multiplying the signal values of each color channel of the sensor image data by a scaling factor, wherein the respective scaling factor is selected uniformly for each color channel, but different scaling factors are selected for the different color channels.

In some embodiments, the generated color image data may be compressed prior to the storing in accordance with a first compression method, wherein the supplementary image data are compressed prior to the storing in accordance with a second compression method that is different from the first compression method. Due to the division into color image data with at least three color channels and into supplementary image data with only a single color channel, different compression methods optimized for the respective image data may be used. The respective compression may take place to different degrees. For example, the color image data may be compressed in accordance with a compression method that is based on a discrete wavelet transform (for example, JPEG XS) or on a discrete cosine transformation (for example, Apple “ProRes”, registered trademark). The supplementary image data, on the other hand, may be compressed in accordance with a compression method that is simpler in terms of the computing effort. For example, the supplementary image data may be quantized, wherein a (further) non-linear transformation of the signal values may optionally be performed beforehand and wherein an entropy coding may be performed after the quantization. The respective compression methods may be carried out independently of one another and do not have to be carried out simultaneously. The respective compression methods may be lossy or lossless compression methods.

The compression methods provided for the color image data and the supplementary image data may also differ in that the one of the first and the second compression method is a temporal compression method, whereas the other of the first and the second compression method is a non-temporal compression method. A temporal compression method is a compression method in which information from a previous frame and/or a subsequent frame of the motion picture sequence is also used for the compression of the image data of a frame of a motion picture sequence (also referred to as “inter-frame” compression). A non-temporal compression method is a compression method in which the compression of the image data of a frame of a motion picture sequence is based only on information of this frame, but not on information of a preceding frame and/or a subsequent frame of the motion picture sequence (also referred to as “intra-frame” compression).

In some embodiments, the color image data may be compressed prior to the storing in accordance with a first temporal compression method, wherein the supplementary image data may be compressed prior to the storing in accordance with a second non-temporal compression method. The fact may be utilized here that a temporal compression method may improve the compression efficiency but is more suitable for the color image data with the relatively low spatial frequencies contained therein than for the supplementary image data with the relatively high spatial frequencies contained therein. In the case of the color image data, the correlation between consecutive frames of a motion picture sequence is particularly high so that a high compression efficiency may be achieved by a temporal compression method without significantly limiting the perceptible image quality.

In other embodiments, the color image data may be compressed prior to the storing in accordance with a first non-temporal compression method, wherein the supplementary image data are compressed prior to the storing in accordance with a second temporal compression method. Such embodiments are, for example, suitable if the post-production (e.g. rough cut) is also to be carried out using the compressed color image data. Accessing the color image data of frames of the compressed motion picture sequence is easier if an offsetting with information from preceding or subsequent frames is not required for this purpose. The supplementary image data used only for a subsequent processing of the (e.g. edited) color image data may, however, be compressed with a temporal compression method of high efficiency.

In some embodiments, the method may comprise an at least two-stage noise reduction (denoising), wherein a first denoising is performed on the sensor image data prior to the steps of generating color image data and generating supplementary image data, and wherein a second denoising is performed on the color image data and on the supplementary image data after the steps of generating color image data and generating supplementary image data and prior to the step of storing the color image data and the supplementary image data.

The first denoising may be performed as part of a pre-processing step that, for example, also comprises said correction of individual sensor image data. The first denoising may, for example, be performed by a filtering based on the signal values of pixels in the environment of the pixel under consideration. This filtering may generally be based on signal values of only the respective color channel, wherein information about structures included in the image content may additionally be taken into account, which information is also determined from the further color channels of the sensor image data (for example, information about the presence and a movement of objects, which information is determined by comparing consecutive frames of a motion picture sequence).

The second denoising is performed after dividing the sensor image data into the color image data and the supplementary image data and may thus take advantage of their characteristics, in particular their different spatial resolutions. The second denoising may be carried out after the mentioned steps of interpolating the sensor image data and transforming the sensor image data into spatial frequency values (for all the color channels or only the first color channel). The second denoising may be performed—at least partly—before or during said compression of the color image data and the supplementary image data. The second denoising may be performed differently with respect to the color image data and the supplementary image data. The second denoising may be performed in a different way, and in particular to a greater extent, with respect to the color image data for spatial frequency values that correspond to high spatial frequencies than for spatial frequency values that correspond to low spatial frequencies. A selectively different denoising for low and high spatial frequencies of the color image data may in particular be based on the spatial frequency values that have been determined by said interpolation and subsequent transformation of the sensor image data, whereby image information separated according to spatial frequencies is already present. However, a selectively different denoising for low and high spatial frequencies of the color image data may also be at least partly based on spatial frequency information that is available as a result of the compression of the color image data and/or the supplementary image data. As explained, the color image data may, for example, be compressed in accordance with a compression method that is based on a discrete wavelet transform or on a discrete cosine transform; in such cases, information is anyway obtained about different spatial frequencies (e.g. in the form of coefficients of the respective compression method) that may be used for a frequency-selective denoising so that the second denoising may be at least partly integrated into said step of compressing the color image data and/or the supplementary image data.

The second denoising of the supplementary image data may be based solely on the signal values of the supplementary image data (for example, by a local low-pass filtering of the supplementary image data), wherein, in some embodiments, information from the color image data may additionally be taken into account (for example, to define or adjust a filter kernel).

Due to the two-stage denoising, image noise present in the sensor image data may be particularly effectively and gently reduced without significantly reducing the quality of the color image data and without significantly restricting the ability of the supplementary image data of subsequently further increasing the quality of the color image data.

In some embodiments, in the second denoising, for the denoising performed on the color image data and/or the supplementary image data with respect to high spatial frequencies, information about existing structures of the respective image content, said information contained in low spatial frequencies, may be taken into account. For example, an edge may be recognizable in spatial frequency values that correspond to low spatial frequencies, wherein such information is used to largely preserve the respective edge structure in spatial frequency values that correspond to high spatial frequencies and not, for instance, to smooth the respective edge structure perceptibly by a filtering or too strong a filtering. The taking into account of such information may also take place temporally (as explained below) and/or in an overlapping manner between the color image data and the supplementary image data, i.e. a structure recognized on the basis of the color image data may also be taken into account for a denoising of the supplementary image data. The taking into account of information about existing structures of the respective image content, said information contained in low spatial frequencies, may, for example, take place by a corresponding definition or adaptation of a filter kernel that is used for the denoising performed on the color image data and/or the supplementary image data with respect to high spatial frequencies.

Due to the segmenting of the sensor image data into the color image data and the supplementary image data, in some embodiments, it is alternatively also possible to perform the second denoising only on the (high-frequency) supplementary image data without modifying the color image data accordingly, wherein the color image data may, however, be used as the basis for the second denoising of the supplementary image data.

In the case of a motion picture sequence, said measures for denoising may also be performed temporally, i.e. the denoising performed on the image data of a frame may also be at least partly based on sensor image data or signal values or spatial frequency values of a preceding frame and/or a subsequent frame of the motion picture sequence.

In some embodiments, the color image data and the supplementary image data may be stored in different data memories. As already explained, a data memory of the camera (for example, a solid-state memory, permanently installed, or a removable storage medium), or a data memory (for example, a recorder) that is locally coupled to the camera in a wired manner, or a data memory (for example, an edge server) that is locally wirelessly coupled to the camera may, for example, be provided as the data memory.

For example, a division that is advantageous for a film production may be provided such that the sensor image data are produced on a film set by an image sensor of a camera, wherein both the color image data and the supplementary image data are stored in a data memory of the camera or in a data memory connected to the camera via a local data connection, and wherein only the color image data—but not the supplementary image data—are additionally stored in a cloud memory via a wide area network (WAN) or the internet. In such an embodiment, based on the color image data stored in the cloud memory, first steps of a post-production (for example, a rough cut) may already be carried out without a time loss without the color image data having to be brought on a physical storage medium to a corresponding data processing device and without the bandwidth for the remote transmission also of the supplementary image data being required. Nevertheless, the relevant image data sets (color image data and supplementary image data) are completely available on the film set and may be stored there, for example.

In an alternative embodiment, the sensor image data may be generated by an image sensor of a camera, wherein the color image data generated in the camera may be stored in a cloud memory only via a wide area network or the internet, and wherein the supplementary image data generated in the camera are only stored in a data memory of the camera or in a data memory connected to the camera via a local data connection (for example, a recorder, edge server) and are thus available for a later processing of the color image data. A relatively low bandwidth is required for the transmission of the color image data to the cloud memory (compared to the complete image data sets, i.e. the color image data and the supplementary image data). In the data memory of the camera or in the data memory connected to the camera, storage capacity is only required for the supplementary image data, but no storage capacity is required for a permanent storage of the entire color image data.

According to a further embodiment, the sensor image data may be generated by an image sensor of a camera, wherein the color image data and the supplementary image data are stored in a cloud memory via a wide area network or the internet, and wherein only the color image data—but not the supplementary image data—are additionally stored in a data memory of the camera or in a data memory connected to the camera via a local data connection. In such an embodiment, the complete image data sets, i.e. the color image data and the supplementary image data, may be made available in a cloud memory without a relevant delay to be able to carry out the desired steps of the post-production based on these image data sets. In the data memory of the camera or in the data memory connected to the camera, on the other hand, only the color image data need to be stored that are already sufficient for checking the recording of a motion picture sequence on the film set and that enable the first steps of a post-production on the film set.

According to a further embodiment, the sensor image data may be generated by an image sensor of a camera, wherein only the color image data—but not the supplementary image data—are stored in a data memory of the camera or in a data memory connected to the camera via a local data connection, and wherein only the supplementary image data—but not the color image data—are stored in a cloud memory via a wide area network or the internet. In such an embodiment, the first steps of a post-production may already be carried out on the film set and the stored color image data may in some cases already be sufficient for a complete post-production in terms of their resolution and quality. On the other hand, access to the supplementary image data stored in the cloud memory may be reserved for a special group of people in order, if necessary, to be able to process the color image data using the supplementary image data. For this purpose, in particular corresponding authorization levels may be assigned, as explained below.

In the present context, a cloud memory is to be understood as a memory (for example, a solid-state memory, magnetic memory, optical memory or other memory of a cloud server or a workstation) which a camera that generates the sensor image data may access directly or indirectly (for example via a local edge server) via a wide area network or the internet (and must access the memory in the absence of a direct cable connection or radio connection).

In some embodiments, the color image data and the supplementary image data may comprise metadata that enable a mutual association of image data sets of the color image data and image data sets of the supplementary image data, said image data sets of the color image data and image data sets of the supplementary image data corresponding to a single image data set of the sensor image data. For example, the metadata may comprise a time stamp. A subsequent processing of the color image data using the supplementary image data is hereby simplified, even if the color image data and the supplementary image data are initially stored in different data memories.

In some embodiments, the color image data and the supplementary image data may be stored in encrypted form, wherein the color image data are encrypted with a first key and the supplementary image data are encrypted with a second key different from the first key. Different authorization levels may hereby be assigned. This is not only advantageous for film productions in order to protect the image data from unauthorized access, but also, for example, to enable a first group of people to process the color image data in accordance with the second spatial resolution and, however, only to permit a restricted second group of people to process the color image data with the aid of supplementary image data in accordance with the (higher) third spatial resolution.

In some embodiments, only the color image data and/or supplementary image data stored in a cloud memory may be stored in encrypted form. In particular, it may be provided that only the supplementary image data are stored in a cloud memory, and indeed only in the cloud memory, wherein access to the supplementary image data should be restricted, as explained above.

As already mentioned, the supplementary image data in combination with the color image data enable a subsequent processing of the color image data (so-called reconstruction).

In some embodiments, the color image data may be converted using the supplementary image data into extended color image data that correspond to a fourth spatial resolution and that comprise at least three color channels, wherein the fourth spatial resolution corresponds to a number of fourth pixels and the extended color image data comprise, for each of the fourth pixels, at least three signal values in accordance with the at least three color channels of the extended color image data, wherein the fourth spatial resolution of the extended color image data is higher than the second spatial resolution of the color image data. The supplementary image data may therefore be used to subsequently increase the spatial resolution of the color image data. This works particularly well if the supplementary image data contain information about high spatial frequencies of the sensor image data and if the supplementary image data contain brightness information that is at least similar for all the color channels. The supplementary image data thus enable a partial or substantially complete reconstruction of the spatial resolution of the sensor image data. Said fourth spatial resolution of the extended color image data may in particular correspond to the first spatial resolution of the sensor image data and/or to the third spatial resolution of the supplementary image data; however, this is not absolutely necessary. The extended color image data may in particular be RGB image data. Such a processing of the color image data may take place regardless of whether the color image data and/or supplementary image data have been compressed and decompressed again in the meantime.

In some embodiments, such a conversion of the color image data into extended color image data may in particular comprise the following steps:
determining further signal values of a first color channel of the at least three color channels of the color image data that corresponds to said single color channel of the supplementary image data (in particular the already mentioned first color channel of the color image data) so that a signal value in accordance with the first color channel of the color image data is present for each of the fourth pixels, wherein these further signal values are determined from the supplementary image data and from signal values of the first color channel of the color image data by transforming spatial frequency values into further signal values or by using the supplementary image data as further signal values;
determining further signal values of the further color channels of the at least three color channels of the color image data so that signal values in accordance with the further color channels of the color image data are present for each of the fourth pixels, wherein these further signal values are determined from the supplementary image data and from signal values of the further color channels of the color image data by transforming spatial frequency values into further signal values or by interpolating signal values of the further color channels of the color image data, wherein the interpolation may in particular take into account gradients derived from the supplementary image data.

When determining further signal values of the first color channel of the at least three color channels of the color image data, said transformation of spatial frequency values into further signal values may in particular comprise transforming the already mentioned spatial frequency values of the single color channel of the supplementary image data that correspond to low and high spatial frequencies. When determining further signal values of the further color channels of the at least three color channels of the color image data, said transformation of spatial frequency values into further signal values may in particular comprise transforming the already mentioned spatial frequency values of the single color channel of the supplementary image data that correspond to low and high spatial frequencies as well as the already mentioned spatial frequency values of the respective color channel of the color image data that correspond to low spatial frequencies, i.e. this information is taken into account in combination. The spatial frequency values of the single color channel of the supplementary image data do not have to be directly taken into account or transformed in this respect; rather, the further signal values may also be included in said transformation that were determined by a previous transformation of the spatial frequency values of the single color channel of the supplementary image data.

When determining further signal values of the first color channel of the at least three color channels of the color image data, said transformation of spatial frequency values into further signal values may in particular take place by an inverse transformation that corresponds to an inverse calculation rule to the above-explained transformation of the respective signal values of the sensor image data into spatial frequency values (for instance by a discrete wavelet transform). For this purpose, a reconstruction kernel may, for example, be used that corresponds to the inverse of the kernel used for a previous discrete wavelet transform.

The same applies to said transformation of spatial frequency values into further signal values when determining further signal values of the further color channels of the at least three color channels of the color image data, wherein this transformation is likewise based on the supplementary image data in combination with signal values of the respective further color channel of the color image data, although the supplementary image data do not correspond to this further color channel of the color image data. Nevertheless, such a combination is suitable since the supplementary image data substantially only provide the (spatially) high-frequency components. If a reversal of a discrete wavelet transform that took place previously is to be carried out in the broadest sense, the LH, HL and HH information (in particular the aforementioned LH, HL and HH spatial frequency values) of the single color channel of the supplementary image data (e.g. green color channel) and the LL information (in particular the aforementioned LL spatial frequency values) of the respective further color channel of the color image data (e.g. red or blue color channel) may be used as input values. For this purpose, a reconstruction kernel may, for example, be used that corresponds to the inverse of the kernel used for a previous discrete wavelet transform, or different reconstruction kernels that are optimized for the respective color channel may be used. The reconstruction kernels may correspond to a respective filtering that uses said spatial frequency values as input values.

Said determination of further signal values of the extended color image data does not preclude the already present signal values of the color image data from also being modified.

If, in the broadest sense, a reversal of a discrete wavelet transform that took place previously is to be performed, some embodiments may use said LL spatial frequency values substantially directly as signal values of the extended color image data. However, in other embodiments (in particular with non-dyadic ratios between the fourth spatial resolution and the second spatial resolution), not only are further signal values of the at least three color channels determined, but the present signal values of the at least three color channels of the color image data are also modified, in particular adapted to changed pixel positions.

As regards the mentioned determination of further signal values of the first color channel by using the supplementary image data as further signal values, as an alternative to an (inverse) transformation, in a particularly simple embodiment for the first color channel of the color image data, the supplementary image data may be used directly or in adapted form as further signal values for the respective matching pixels, wherein, for the adapting, an adapting of the signal values of the supplementary image data to offset pixel positions is required, and the fourth spatial resolution of the extended color image data does not match the third spatial resolution of the supplementary image data.

As regards the mentioned determination of further signal values of the further color channels by interpolating signal values of the further color channels of the color image data, as an alternative to an (inverse) transformation for the further color channels of the color image data, the further signal values may be determined by interpolating the signal values of the respective further color channel of the color image data. For this purpose, in some embodiments, a gradient may be derived from the supplementary image data and this gradient may be used as the basis for the weighting of said interpolation. The gradient may be derived directly from the supplementary image data, or only indirectly, namely from the reconstructed signal values of said single color channel of the supplementary image data. In particular, the gradient may be a signal value gradient of signal values of said single color channel of the supplementary image data.

In other embodiments, said conversion of the color image data into extended color image data may in particular comprise the following steps:
feeding the color image data and the supplementary image data into a neural network; and
generating the extended color image data by the neural network.

A previously trained neural network may be used for this purpose.

If a transformation of the signal values of the sensor image data has previously taken place by a discrete wavelet transform, said LL, LH, HL and HH spatial frequency values of the single color channel of the supplementary image data (e.g. green color channel) and the respective LL spatial frequency values of the further color channels of the color image data (e.g. red and blue color channel) may, for example, be entered as input values into the neural network in order to determine the extended color image data in accordance with the fourth spatial resolution with at least three color channels.

The neural network may also perform additional image processing steps, such as a denoising, as a result of appropriate training.

In all the explained embodiments for a subsequent processing of the color image data using the supplementary image data, a color processing (for example, a color space transformation) may optionally also be performed after the processing.

In other embodiments, a color processing (in particular a color space transformation) of the color image data may already be performed before the processing of the color image data. The computing effort for the processing of the color image data may hereby be reduced since said color image data do not yet have an extended scope.

In some applications, a processing of the color image data using the supplementary image data may also comprise a refocusing of the color image data (i.e. sharpening) for an image region of a respective frame. In particular, the color image data may, using the supplementary image data, be converted into regionally focused color image data that correspond to the second spatial resolution and comprise at least three color channels, wherein, for a limited image region that corresponds to a contiguous part of the second pixels but that is smaller than the entire respective single image, the signal values of one, a plurality of or all of the at least three color channels of the color image data are modified by adjusting these signal values to a value development within the supplementary image data. A spatial high-frequency information of the supplementary image data may hereby be transmitted to the color image data.

In other applications, a processing of the color image data using the supplementary image data may also comprise a brightness processing (so-called highlight recovery). In particular, it may be provided that the color image data are modified by performing a color space transformation on the color image data, wherein, after the color space transformation has been performed, the color image data are corrected in terms of their respective brightness in dependence on the supplementary image data. For example, a color matching may be carried out in which the at least three color channels of the color image data are offset against one another, wherein partly irreversible changes are made to the image data. As a result, brightness information within the respective color channel may be lost. However, after performing the color space transformation, the color image data may be corrected with regard to their respective brightness in dependence on the supplementary image data, for example, by transferring direction-dependent brightness developments of the supplementary image data to the color image data modified in this way. Between the modifying of the color image data (e.g. color matching) and the brightness processing, the color image data may also be compressed, stored, read out and decompressed.

Furthermore, a processing of the color image data using the supplementary image data may also comprise generating enlarged image sections with the same resolution as the starting image, i.e. corresponding to the second spatial resolution of the color image data (so-called reframing). In particular, it may be provided that the color image data of a limited image region, which corresponds to a contiguous part of the second pixels but is smaller than the entire respective frame, are selected (for example by a user in post-production), wherein the non-selected color image data are discarded and the signal values and pixel positions corresponding to the selected color image data are scaled to the second spatial resolution (for example by interpolation), wherein the scaled signal values are modified in dependence on the supplementary image data in order to adapt a focus development and/or a brightness development of the scaled signal values to a value development within the supplementary image data. For example, a spatial high-frequency information of the supplementary image data may hereby be transferred to the scaled color image data. For example, the scaling may take place based on a spatial filtering that directly or indirectly takes into account a signal value gradient of the supplementary image data.

In further applications, a processing of the color image data using the supplementary image data may comprise an only temporary local increase in the resolution of the image data for a variable image region. In particular, it may be provided that during an ongoing shooting of a motion picture sequence by means of a camera, the color image data are converted into extended color image data of a higher resolution in dependence on the supplementary image data for a limited image region, which is smaller than the entire respective frame of the motion picture sequence, and are displayed on a display device (for example, a monitor or viewfinder). For example, during the recording of a motion picture scene in the camera, only the color image data in accordance with the second spatial resolution may generally be processed in order to provide the user with a preview image. A processing of the full resolution (first spatial resolution of the sensor image data) is often not possible or not desired in the camera due to limited computing resources. However, a camera assistant (for example, a so-called focus puller) sometimes requires the full resolution or a higher resolution than said second spatial resolution of the color image data to be able to assess on a display device, based on a display of the image data, whether the focus is correctly set at the camera lens. In such a case, the supplementary image data may be used to upscale the image processed in the relatively low second resolution and to offer an increased resolution or the full resolution at least for a selectable limited image region that is smaller than the entire respective frame (crop out).

In some applications, the supplementary image data may be used for generating electronic keying masks (so-called chroma keys), wherein the supplementary image data are used to separate foreground image information from background image information in the color image data. During the post-processing of a recorded motion picture scene, it is often necessary to key out an actor from the background (e.g. for green screen shots). The full resolution is often not used when working on visual effects since this requires a great deal of computing capacity and memory space. However, for a keying out of an actor from the background, higher resolutions than that of the final image produced are often advantageous in order to precisely capture fine structures (such as hair). According to an advantageous application, the color image data may therefore be used for the actual rendering of the final image, while the supplementary image data are only used for the explained keying out of a foreground from the background.

The invention also relates, independently of the generating and storing of the color image data and supplementary image data, to a method for processing color image data that are based on sensor image data of a first spatial resolution using supplementary image data, wherein the method comprises the following steps:
providing color image data that correspond to a second spatial resolution and that comprise at least three color channels, wherein the second spatial resolution corresponds to a number of second pixels and the color image data comprise, for each of the second pixels, at least three signal values in accordance with the at least three color channels of the color image data;
providing supplementary image data that correspond to a third spatial resolution and that comprise only a single color channel, wherein the third spatial resolution corresponds to a number of third pixels and the supplementary image data comprise, for each of the third pixels, only one signal value in accordance with the single color channel of the supplementary image data; and
converting the color image data using the supplementary image data into extended color image data that correspond to a fourth spatial resolution and comprise at least three color channels, wherein the fourth spatial resolution corresponds to a number of fourth pixels and the extended color image data comprise, for each of the fourth pixels, at least three signal values in accordance with the at least three color channels of the extended color image data, wherein the fourth spatial resolution of the extended color image data is higher than the second spatial resolution of the color image data.

This method may moreover be carried out and further developed as explained above for the different embodiments. In particular, the conversion of the color image data into extended color image data using the supplementary image data may comprise the following steps:
determining further signal values of a first color channel of the at least three color channels of the color image data that corresponds to said single color channel of the supplementary image data so that a signal value in accordance with the first color channel of the color image data is present for each of the fourth pixels, wherein these further signal values are determined from the supplementary image data and from the signal values of the first color channel of the color image data by transforming spatial frequency values into further signal values or by using the supplementary image data as additional signal values;
determining further signal values of the further color channels of the at least three color channels of the color image data so that signal values in accordance with the further color channels of the color image data are present for each of the fourth pixels, wherein these further signal values are determined from the supplementary image data and from the signal values of the further color channels of the color image data by transforming spatial frequency values into further signal values or by interpolating signal values of the further color channels of the color image data, wherein the interpolation may in particular take into account a gradient derived from the supplementary image data.

The explained method for processing and storing image data may, as already mentioned, be carried out partly or completely in a data processing device separate from a camera. However, the method may also be carried out partly or completely in a camera. The invention thus also relates to a camera system comprising a camera and at least one data memory, wherein the camera has an image sensor for generating sensor image data and a signal processing device for processing the sensor image data, wherein the at least one data memory is connected or may be coupled to the camera, and wherein the signal processing device is configured to carry out the method according to any one of the embodiments explained above. As explained, the image sensor may comprise a plurality of light-sensitive sensor elements, wherein the sensor image data correspond to image signals of the light-sensitive sensor elements. As explained, the signal processing device may comprise a microprocessor, a central processing unit (CPU), a graphics processing unit (GPU), an application-specific integrated circuit (ASIC) and/or a field programmable gate array (FPGA).

The camera may further comprise readout electronics that are associated with the image sensor and that comprise different components. The readout electronics of the camera may, for example, comprise amplifiers, analog-to-digital converters or electronic components for signal processing or control, in particular a microprocessor, a central processing unit (CPU), a graphics processing unit (GPU), an application-specific integrated circuit (ASIC), and/or or a field programmable gate array (FPGA).

The camera may further comprise the aforementioned display device (for example, a monitor, viewfinder) for displaying a recorded motion picture sequence (in particular the color image data).

The invention will be explained in the following only by way of example with reference to the drawings. Elements that are the same or of the same kind are provided with the same reference numerals therein.

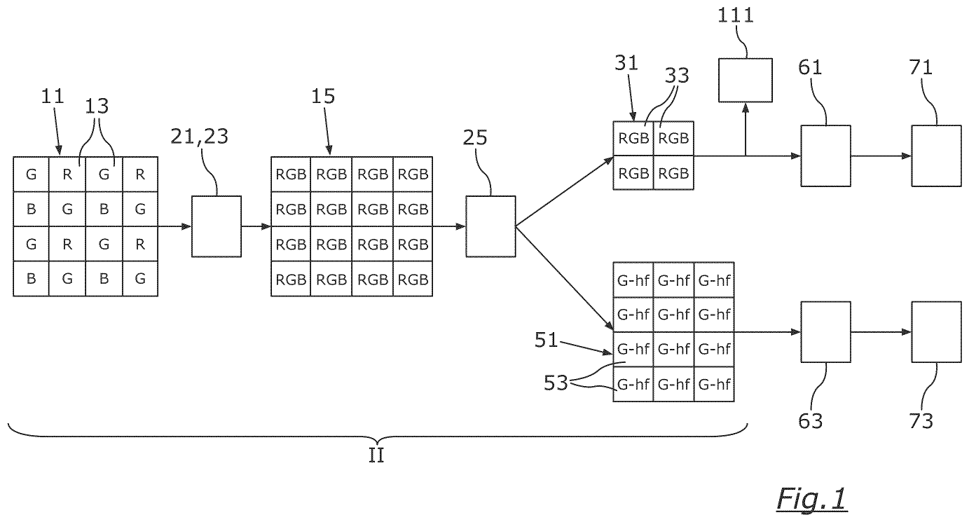

FIG. 1 schematically shows the sequence of a method for generating color image data and supplementary image data of different spatial resolutions based on the sensor image data;

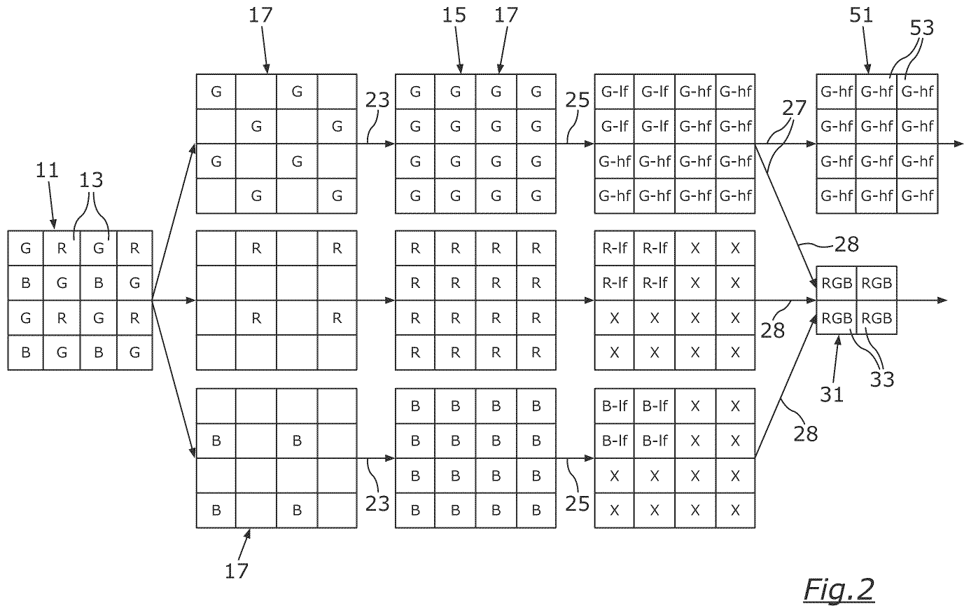

FIG. 2 shows details of an embodiment of the method in accordance with FIG. 1;

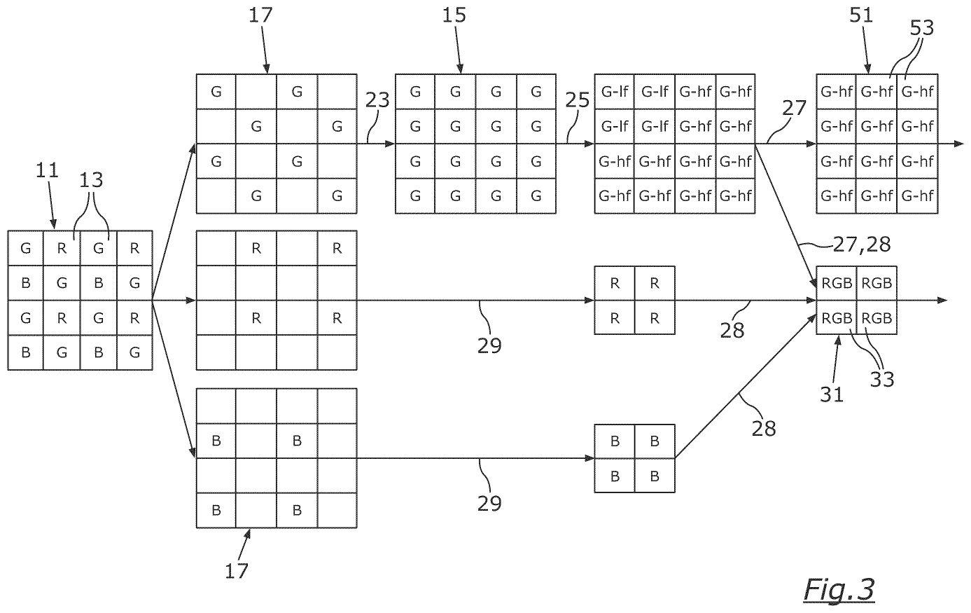

FIG. 3 shows details of a modification of the method in accordance with FIG. 1;

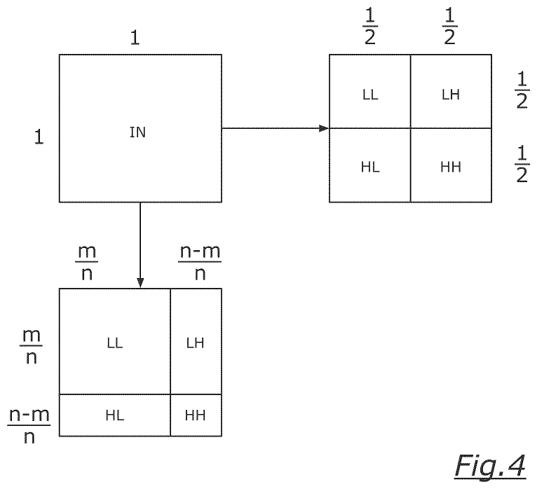

FIG. 4 illustrates possible ratios between the output values of a discrete wavelet transform;

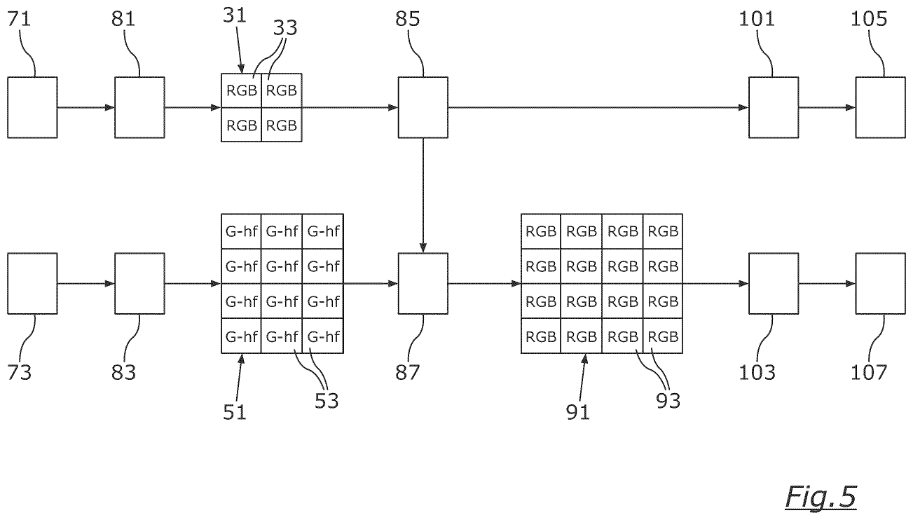

FIG. 5 shows the sequence of a method for converting color image data into extended color image data by using supplementary image data of a higher spatial resolution; and

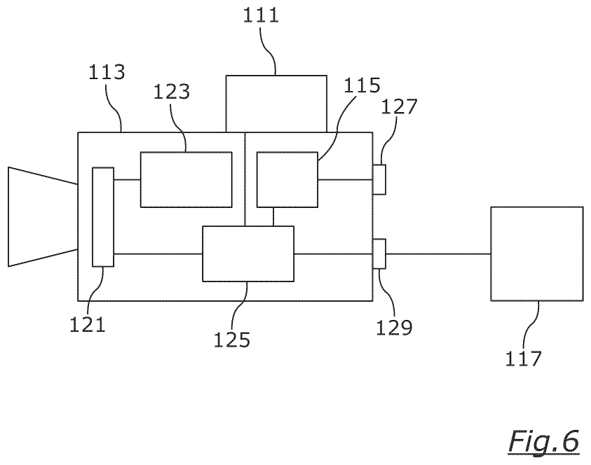

FIG. 6 shows a camera system comprising a camera and two data memories for carrying out the method in accordance with FIG. 1.

The method shown in FIG. 1 is based on sensor image data 11 that have been or will be generated by an image sensor of a camera before or during the carrying out of the method, for example by the camera shown in FIG. 6.

The sensor image data 11 are available as mosaic image data in accordance with the Bayer pattern of the image sensor used, wherein, in relation to an arrangement of four pixels arranged in two rows and two columns, two pixels arranged diagonally to one another are assigned a green signal value G and the two remaining pixels are assigned a red signal value R and a blue signal value B, respectively. The sensor image data 11 have a first spatial resolution and comprise three color channels, namely corresponding to the green, red and blue signal values G, R, B. Said first spatial resolution corresponds to a number of first pixels 13, of which only a total of 16 pixels 13 are shown by way of example. Only one signal value G, R or B is associated with each of the first pixels 13.

Optionally, a correction of individual sensor image data may take place in a preprocessing step 21 and/or a white balance may be performed between the three color channels of the sensor image data 11. Furthermore, a (first) denoising may optionally be performed on the sensor image data 11 in the pre-processing step 21.

Based on the sensor image data 11, color image data 31 and supplementary image data 51 of different spatial resolutions are generated. For this purpose, in the embodiment example in accordance with FIG. 1, the sensor image data 11 are first interpolated in an interpolation step 23 in order to determine two further signal values for each of the first pixels 13, namely corresponding to the respective color channels not yet represented, so that a respective signal value G, R, B is now present for each of the first pixels 13 and for each of the three color channels of the sensor image data 11. In the interpolation step 23, signal values G, R, B of the respective other color channels and/or their gradients may also be taken into account. The number of pixels 13 of the interpolated image data 15 is unchanged. An RGB image of a high resolution is thus present that, however, without further measures, would require correspondingly high storage, bandwidth and computing capacities.

In a subsequent transformation step 25, for each of the three color channels of the interpolated image data 15, the signal values R, G, B are transformed into spatial frequency values by a discrete wavelet transform. The interpolated image data 15 are hereby segmented into different spatial frequencies. As color image data 31, for each of the three color channels, such spatial frequency values are now determined that correspond to low spatial frequencies of the (transformed) sensor image data signal values, wherein the color image data 31, corresponding to the selected low spatial frequencies, have a lower second spatial resolution and accordingly comprise a lower number of second pixels 33 than the sensor image data 11. Four second pixels 33 are shown by way of example. A respective signal value G, R, B is present for each of the second pixels 33 and for each of the three color channels of the color image data 31. Thus, the color image data 31 form an RGB image that is already directly observable (but with an unnatural frequency distribution) and that may be observed with an almost natural frequency distribution as a result of an optional filter step. For example, the first spatial resolution of the sensor image data 11 may amount to 8K, while the second spatial resolution of the color image data 31 amounts to 4K. However, non-dyadic ratios are also possible (for example 8K to 6K), depending on the selection of the low spatial frequencies after the transformation of the sensor image data 11.

The supplementary image data 51 are generated by selecting the relatively higher spatial frequencies of the (transformed) sensor image data signal values, and indeed only for a single color channel that best represents the spatial change in the brightness distribution. This is the color channel for which the signal values G of the sensor image data 11 have the highest relative frequency; as explained, this is the green color channel. The supplementary image data 51, corresponding to the selected relatively higher spatial frequencies, have a third spatial resolution that corresponds to a number of third pixels 53. The supplementary image data 51 do not represent any color information and comprise only a single spatial frequency value Ghf, which corresponds to a high spatial frequency, for each of the third pixels 53.

Optionally, a (second) denoising may now be performed on the color image data 31 and on the supplementary image data 51. This denoising may be performed differently with respect to the color image data 31 and the supplementary image data 51 and may be performed in a different manner respect to the color image data 31 for spatial frequency values that correspond to high spatial frequencies than for spatial frequency values that correspond to low spatial frequencies.

The color image data 31 and the supplementary image data 51 may now be stored directly and independently of one another. If the sensor image data 11 are associated with a motion picture sequence that is recorded by a camera, the already generated color image data 31 may, however, also be displayed on a display device 111 of the camera (for example, a camera viewfinder, monitor) during the still continuing generation of further sensor image data 11.

For many applications, it is further desired for the image data to be compressed for the storage and for the transmission to a respective data memory. A particular advantage of segmenting the sensor image data 11 into the color image data 31 and the supplementary image data 51 is that in each case particularly suitable and thus efficient compression methods may be used for these two different types and formats of image data 31, 51. Thus, a respective compression step 61 and 63 may first be performed for the color image data 31 and the supplementary image data 51. For example, the color image data 31 may be compressed in accordance with a compression method that is based on a discrete wavelet transform or a discrete cosine transform with a subsequent quantization and entropy encoding, while the supplementary image data 51 may be compressed in accordance with a compression method that is based directly on a quantization with a subsequent entropy encoding (i.e., without a preceding discrete wavelet transform or discrete cosine transform).

Regardless of whether such a compression of the respective image data and/or a denoising takes place, the color image data 31 and the supplementary image data 51 may now be stored, namely in a common data memory or in separate data memories 71 or 73. The storing of the color image data 31 and the supplementary image data 31 in any case takes place such that the color image data 31 may be accessed independently of the supplementary image data 51. Thus, the color image data 31 may be subjected to first further processing steps, whereas a processing of the color image data 31 using the supplementary image data 51 may selectively only take place at a later point in time or in a later stage of the processing of the color image data 31.

If the sensor image data 11 are generated by an image sensor of a camera, the color image data 31 and/or the supplementary image data 51 may, for example, be stored via a wide area network (WAN) or the internet in a cloud memory as a data memory 71, wherein the color image data 31 and/or the supplementary image data 51 may (in each case alternatively or additionally) be stored in a data memory 73 of the camera or in a data memory 73 connected to the camera via a local data connection.

FIG. 2 shows further details of the method explained above for a more detailed explanation of the section II in accordance with FIG. 1.

FIG. 2 illustrates that the three color channels of the sensor image data 11 are represented differently according to the Bayer pattern, wherein the relative frequency of green signal values G is twice as high as the relative frequency of red signal values R or blue signal values B. As a result of the interpolation 23, for each of the first pixels 13, three signal values G, R or B are present that are illustrated in FIG. 2 as three separate color planes 17, corresponding to the three color channels. Due to the transformation 25 (including a segmenting according to spatial frequencies), green signal values (spatial frequency values Glf) of a low spatial frequency and transformed green signal values (spatial frequency values Ghf) of a high spatial frequency are produced for the green signal values G. Furthermore, due to the transformation 25, transformed red signal values (spatial frequency values Rlf) of a low spatial frequency are produced for the red signal values R, wherein transformed red signal values of a high spatial frequency are not produced or are immediately discarded (symbolized by “X” in FIG. 2). The same applies to the blue color channel, i.e. transformed blue signal values (spatial frequency values Blf) of a low spatial frequency are produced by the transformation 25 for the blue signal values B, wherein transformed blue signal values of a high spatial frequency are not produced or are immediately discarded. The transformed green signal values (spatial frequency values Ghf) of the high spatial frequency form a separate data set of the supplementary image data 51 due to a selection step 27. The transformed green signal values (spatial frequency values Glf) of the low spatial frequency, the transformed red signal values (spatial frequency values Rif) of the low spatial frequency and the transformed blue signal values (spatial frequency values Blf) of the low spatial frequency are combined in a combination step 28 to form a separate data set of the color image data 31.

FIG. 3 shows details of a modification of the method in accordance with FIG. 1, wherein the modification relates to the section II in accordance with FIG. 1 and the further steps in accordance with FIG. 1 (display of the color image data, optionally, denoising, compression, storage of the image data) may also be performed in the modification in accordance with FIG. 3.

The starting point is again sensor image data 11 that have been or will be generated by an image sensor of a camera. The sensor image data 11 are present as mosaic image data and have a first spatial resolution with a number of first pixels 13. The sensor image data 11 comprise three color channels, wherein only one signal value G, R or B is associated with each of the first pixels 13. Optionally, a pre-processing step 21 may be carried out as explained in connection with FIG. 1.

Based on the sensor image data 11, color image data 31 and supplementary image data 51 of different spatial resolutions are generated. For this purpose, in the embodiment example in accordance with FIG. 3, the sensor image data 11 only of the green color channel are interpolated in an interpolation step 23 in order to determine a green signal value G for those of the first pixels 13 for which no signal value is yet present in accordance with the green color channel. In the interpolation step 23, signal values R, B of the other color channels and/or their gradients may also be taken into account. Thus, a signal value G in accordance with the green color channel is present for each of the first pixels 13. In a subsequent transformation step 25, the signal values G are transformed into spatial frequency values by a discrete wavelet transform (only) for the green color channel of the interpolated image data 15. The interpolated image data 15 of the green color channel are hereby segmented into different spatial frequencies.

The supplementary image data 51 are generated by selecting the relatively higher spatial frequencies of the (transformed) green signal values (selection step 27), and indeed only for the green color channel that—as explained above—best represents the spatial change of the brightness distribution. Due to the transformation 25 (including a segmenting according to spatial frequencies), transformed green signal values (spatial frequency values Glf) of a (relatively) low spatial frequency and transformed green signal values (spatial frequency values Ghf) of a (relatively) high spatial frequency are generated for the green signal values G. The transformed green signal values (spatial frequency values Ghf) of the high spatial frequency form a separate data set of the supplementary image data 51. The supplementary image data 51, corresponding to the selected spatial frequencies, have a third spatial resolution that corresponds to a number of third pixels 53. The supplementary image data 51 do not represent any color information and only comprise a single spatial frequency value Ghf, which corresponds to a high spatial frequency, for each of the third pixels 53.

To generate the color image data 31, different procedures are used for the green color channel, on the one hand, and for the red color channel and the blue color channel, on the other hand. The color image data 31 of the green color channel are determined in a or the selection step 27 by selecting the transformed green signal values (spatial frequency values Glf) of the low spatial frequency. The color image data 31 of the red color channel and the blue color channel are generated by adapting the red and blue signal values of the sensor image data 11 to pixel positions that correspond to the pixel positions of the transformed green signal values (spatial frequency values Glf) (adapting step 29). This adapting of the red and blue signal values to the aforementioned pixel positions may, for example, take place by a spatial filtering that takes into account the signal values R, B of the respective color channel (i.e. red or blue) at adjacent pixel positions and signal values G of the green color channel at adjacent pixel positions (preferably not only the original, but also the interpolated green signal values G). In particular, the signal values R, B of the respective color channel at adjacent pixel positions may be taken into account by applying a weighted interpolation, wherein the signal values G of the green color channel at adjacent pixel positions are used to determine the weighting of said interpolation, for example, by forming a gradient of the signal values G of the green color channel (original signal values and preferably also interpolated signal values). The selected color image data 31 of the green color channel (spatial frequency values Glf of the low spatial frequency) and the adapted red and blue signal values R, B are combined in a combination step 28 to form a separate data set of the color image data 31.

The color image data 31 have a second spatial resolution that is lower than the first spatial resolution of the sensor image data 11 and that, in accordance with the relative frequency of the different signal values G, R, B within the sensor image data 11 in the case of a Bayer pattern, may be a quarter of the first spatial resolution, for example. The color image data 31 comprise a smaller number of second pixels 33, which number corresponds to the lower second spatial resolution, than the sensor image data 11. The third spatial resolution of the supplementary image data 51 may be higher than the second spatial resolution of the color image data 31; however, this is not necessarily the case.

Also in the embodiment example in accordance with FIG. 3, the color image data 31 and the supplementary image data 51 may now be stored directly independently of one another, as explained in connection with FIG. 1.

FIG. 4 refers to the output values of a discrete wavelet transform in accordance with the transformation step 25 of FIG. 1 or FIG. 3 and illustrates possible ratios between the spatial frequency values of a higher spatial frequency and the spatial frequency values of a lower spatial frequency. As explained, the output values of the discrete wavelet transform may be divided into LL spatial frequency values (low-pass filtering in the horizontal and the vertical direction), LH spatial frequency values (low-pass filtering in the horizontal direction, high-pass filtering in the vertical direction), HL spatial frequency values (high-pass filtering in the horizontal direction, low-pass filtering in the vertical direction) and HH spatial frequency values (high-pass filtering in the horizontal and the vertical direction).

The square with side length 1 symbolizes the number of input values IN (corresponding to the resolution of the input image data). The side lengths and corresponding sizes of the further squares or rectangles in FIG. 4 symbolize the number of output values (spatial frequency values) for the different frequency ranges LL, LH, HL and HH. The total number of output values is indeed the same as the number of input values. However, the assignment of the output values to the different frequency ranges depends on the desired number of output values relative to the number of input values. The limit value of the filtering according to spatial frequencies must be selected accordingly.

The arrow to the right shows the case of a dyadic ratio between the resolution of the input image data IN (for example, the green color channel of the interpolated image data 15 in accordance with FIG. 1) and the resolution of the output image data LL of a low spatial frequency in the horizontal and the vertical direction (for example, the green color channel of the color image data 31 in accordance with FIG. 1) that amounts to a quarter of the resolution of the input image data IN here. With reference to FIG. 1, this means that the third spatial resolution of the supplementary image data 51 (LH, HL and HH spatial frequency values) is greater than the second spatial resolution of the color image data 31 by a factor of 3.

The arrow pointing downwards shows the case of a non-dyadic ratio between the resolution of the input image data IN and the resolution of the output image data LL due to a correspondingly selected cut-off frequency. Here, the second spatial resolution (for example, color image data 31 in accordance with FIG. 1) may be greater than the third spatial resolution (for example, supplementary image data 51 in accordance with FIG. 1).

FIG. 5 illustrates the sequence of a method for converting color image data 31 into extended color image data 91 by using associated supplementary image data 51 of a higher spatial resolution (so-called reconstruction).

The starting point may be color image data 31 that have a second spatial resolution and that are read out from a data memory 71 and supplementary image data 51 that have a third spatial resolution and that are read out from the same data memory 71 or another data memory 73.

It is assumed that the color image data 31 and the extended color image data 91 correspond to the Bayer pattern and thus have a greater relative frequency of green signal values G than the respective relative frequency of red signal values R or blue signal values B, as explained in connection with FIGS. 1 to 3.

It is further assumed that the supplementary image data 51 were generated by a transformation 25 (including a segmenting according to spatial frequencies) and are formed by transformed green signal values (spatial frequency values Ghf) of a high spatial frequency, as explained in connection with FIGS. 1 to 3.

If the color image data 31 and/or the supplementary image data 51 are stored in compressed form, a decompression of the respective image data 31, 51 may take place in a respective decompression step 81 or 83. The color image data 31 may optionally also be subjected to a white balance correction in a step 85.

In a processing step 87, the color image data 31 are converted into extended color image data 91 using the supplementary image data 51, said extended color image data 91 corresponding to a fourth spatial resolution and comprising three color channels, namely green, red and blue. The fourth spatial resolution corresponds to a number of fourth pixels 93, wherein the extended color image data 91 comprise three signal values G, R, B for each of the fourth pixels 93. In other words, the extended color image data 91 form an RGB image data set. As illustrated in FIG. 5, the fourth spatial resolution of the extended color image data 81 is higher than the second spatial resolution of the color image data 31 and also higher than the third spatial resolution of the supplementary image data 51.

For the conversion of the color image data 31 into extended color image data 91, further green signal values G of the green color channel of the color image data 31 may be determined corresponding to the fourth spatial resolution in the processing step 87 so that a green signal value G is present for each of the fourth pixels 93. These further green signal values G may be determined from the supplementary image data 91 (spatial frequency values Ghf of a high spatial frequency) and from the green signal values G of the color image data 31 by a transformation. This transformation may correspond to an inverse of the transformation used for generating the supplementary image data 51.

Furthermore, in the processing step 87, further red signal values R and further blue signal values B of the red color channel or of the blue color channel of the color image data 31 may be determined corresponding to the fourth spatial resolution so that a red signal value R and a blue signal value B are also present for each of the fourth pixels 93. For this purpose, the fact is utilized that the red signal values R and the blue signal values B of the color image data 31 may be treated as spatial frequency values of a low spatial frequency in view of the (relatively low) second spatial resolution (without the red signal values R and the blue signal values B necessarily having been generated by a frequency segmentation). The further red signal values R and blue signal values B may be determined from the supplementary image data 51 (spatial frequency values Ghf with a brightness information of a high spatial frequency) and from the red signal values R and blue signal values B of the color image data 31 (corresponding to spatial frequency values with a respective color information of a low spatial frequency) by a transformation that corresponds to a filtering which uses said spatial frequency values as input values. As a result, further red signal values R and blue signal values B may ultimately be interpolated, to which signal values the high spatial frequency of the spatial frequency values Ghf of the supplementary image data 51 is imparted. The mixing of the color channels (green color channel of the supplementary image data 51 with the red color channel and the blue color channel of the color image data 31) taking place in this respect is possible because substantially only the (high-frequency) brightness information of the green color channel is adopted.

Thus, extended color image data 91 are now available as an RGB image with the relatively high fourth spatial resolution. The color image data 31 with the relatively low second spatial resolution may also continue to be useful in view of the small requirement for storage capacity, bandwidth capacity and computing capacity. Optionally, in a further respective image processing step 101, 103, a color processing or other processing may also be performed that may now also be irreversible. Finally, the processed color image data 31 and the processed extended color image data 91 may be supplied to a respective data memory 105, 107.

FIG. 6 shows a camera system comprising a camera 113 and two data memories 115, 117. The camera 113 comprises an image sensor 121 for generating sensor image data 11, readout electronics 123 for controlling the image sensor 121 and for reading out the sensor image data 11, and a signal processing device 125 for processing the sensor image data 11, wherein the signal processing device 125 is configured to carry out the method according to any one of the above-explained embodiments or parts thereof. The image sensor 121 may, as explained, comprise a plurality of light-sensitive sensor elements that are arranged in columns and rows, wherein the light-sensitive sensor elements are provided with a color filter array.

The camera 113 also comprises the already mentioned display device 111 that may display the already generated color image data 31 during a recording of a motion picture sequence.

The one data memory 115 is arranged within the camera 113 (permanently integrated or as a removable storage medium). Color image data 31 and/or supplementary image data 51 may be stored in the data memory 115 and may be selectively read out via a signal output 127 independently of one another. The further data memory 117 is releasably connected to a signal output 129 of the camera 113 and may record color image data 31 and/or supplementary image data 51 immediately after their generation. The further data memory 117 may, for example, be selectively coupled to the camera 113 via a cable, a local network (in a wired or wireless manner) or via a wide area network (WAN) or the internet.

Reference numeral list

| | |
|---|---|
| 11 | sensor image data |
| 13 | pixel of the sensor image data |
| 15 | interpolated image data |
| 17 | color plane |
| 21 | pre-processing |
| 23 | interpolation |
| 25 | transformation |
| 27 | selection |
| 28 | combination |
| 29 | adaptation |
| 31 | color image data |
| 33 | pixel of the color image data |
| 51 | supplementary image data |
| 53 | pixel of the supplementary image data |
| 61 | compression |
| 63 | compression |
| 71 | data memory |
| 73 | data memory |
| 81 | decompression |
| 83 | decompression |
| 85 | white balance correction |
| 87 | processing |
| 91 | extended color image data |
| 93 | pixel of the extended color image data |
| 101 | image processing |
| 103 | image processing |
| 105 | data memory |
| 107 | data memory |
| 111 | display device |
| 113 | camera |
| 115 | data memory |
| 117 | data memory |
| 121 | image sensor |
| 123 | readout electronics |
| 125 | signal processing device |
| 127 | signal output |
| 129 | signal output |
| G | green signal value |
| R | red signal value |
| B | blue signal value |
| Glf | green spatial frequency value of a low spatial frequency |
| Ghf | green spatial frequency value of a high spatial frequency |
| Rlf | red spatial frequency value of a low spatial frequency |
| Blf | blue spatial frequency value of a low spatial frequency |
| IN | input image data |
| LL, LH, | output image data |
| HL, HH | |

1. A method for processing and storing image data, comprising the steps:
providing sensor image data of an image sensor of a camera, wherein the sensor image data have a first spatial resolution and comprise at least three color channels, wherein the first spatial resolution corresponds to a number of first pixels and the sensor image data comprise, for each of the first pixels, only one signal value from one of the at least three color channels of the sensor image data;
based on the sensor image data, generating color image data that correspond to a second spatial resolution and that comprise at least three color channels, wherein the second spatial resolution corresponds to a number of second pixels and the color image data comprise, for each of the second pixels, at least three signal values in accordance with the at least three color channels of the color image data, wherein the second spatial resolution of the color image data is lower than the first spatial resolution of the sensor image data;
based on the sensor image data, generating supplementary image data that correspond to a third spatial resolution and that comprise only a single color channel, wherein the third spatial resolution corresponds to a number of third pixels and the supplementary image data comprise, for each of the third pixels, only one signal value in accordance with the single color channel of the supplementary image data; and
storing the color image data and the supplementary image data such that the color image data can be accessed independently of the supplementary image data.

2. A method according to claim 1,
further comprising the step:
generating the sensor image data by means of an image sensor of a camera, said image sensor comprising a plurality of light-sensitive sensor elements that are arranged in columns and rows.

3. A method according to claim 1,
wherein the sensor image data are associated with a motion picture sequence, wherein color image data already generated during a generating of further sensor image data of the motion picture sequence are displayed on a display device of the camera.

4. A method according to claim 1,
wherein the third spatial resolution of the supplementary image data is higher than the second spatial resolution of the color image data; and/or
wherein the third spatial resolution of the supplementary image data is lower than the first spatial resolution of the sensor image data.

5. A method according to claim 1,
wherein the color image data correspond to low spatial frequencies of the sensor image data, and wherein the supplementary image data correspond to high spatial frequencies of the sensor image data.

6. A method according to claim 1,
wherein the signal values in accordance with the single color channel of the supplementary image data and the signal values in accordance with that color channel of the color image data which corresponds to the single color channel of the supplementary image data together substantially comprise the information content of the color channel of the sensor image data that corresponds to the single color channel of the supplementary image data.

7. A method according to claim 1,
wherein the step of generating the color image data based on the sensor image data comprises the following processing steps:
interpolating the sensor image data in order to determine at least two further signal values for each of the first pixels so that a respective signal value is present for each of the first pixels and for each of the at least three color channels of the sensor image data;
for each of the at least three color channels of the sensor image data, transforming the signal values including the interpolated signal values into spatial frequency values that correspond to low and high spatial frequencies; and
determining the color image data for each of the at least three color channels of the color image data by selecting spatial frequency values that correspond to low spatial frequencies; and
wherein the step of generating the supplementary image data based on the sensor image data comprises the following processing step:
determining the supplementary image data for the single color channel of the supplementary image data by selecting spatial frequency values that correspond to high spatial frequencies.

8. A method according to claim 7,
wherein the transforming of the signal values into spatial frequency values takes place by means of a discrete wavelet transform.

9. A method according to claim 1,
wherein the step of generating the color image data based on the sensor image data comprises the following processing steps:
for only a first color channel of the at least three color channels of the sensor image data that corresponds to said single color channel of the supplementary image data, interpolating the sensor image data in order to determine a signal value in accordance with the first color channel for those of the first pixels for which no signal value in accordance with the first color channel is yet present;
for the first color channel of the sensor image data, transforming the signal values including the interpolated signal values into spatial frequency values that correspond to low and high spatial frequencies;
determining the color image data for a first color channel of the at least three color channels of the color image data that corresponds to the first color channel of the sensor image data by selecting spatial frequency values of the first color channel that correspond to low spatial frequencies; and
determining the color image data for the further ones of the at least three color channels of the color image data by adapting the signal values in accordance with the further ones of the at least three color channels of the sensor image data to pixel positions that correspond to the color image data of the first color channel; and
wherein the step of generating the supplementary image data based on the sensor image data comprises the following processing step:
determining the supplementary image data for the single color channel of the supplementary image data by selecting spatial frequency values that correspond to high spatial frequencies.

10. A method according to claim 9,
wherein the adapting of the signal values takes place by a spatial filtering that takes into account signal values of the respective further color channel of the sensor image data at adjacent pixel positions and signal values of the first color channel of the sensor image data at adjacent pixel positions.

11. A method according to claim 1,
wherein at least one of the following steps is performed prior to the step of generating color image data:
correcting individual sensor image data that correspond to defective or greatly deviating sensor elements of the image sensor;
performing a non-linear transformation of the sensor image data within each of the at least three color channels of the sensor image data; or
performing a white balance between the at least three color channels of the sensor image data.

12. A method according to claim 1,
wherein the color image data are compressed prior to the storing in accordance with a first compression method, and wherein the supplementary image data are compressed prior to the storing in accordance with a second compression method that is different from the first compression method.

13. A method according to claim 12,
wherein the first compression method is a temporal compression method, and wherein the second compression method is a non-temporal compression method.

14. A method according to claim 1,
wherein an at least two-stage denoising is performed,
wherein a first denoising is performed on the sensor image data prior to the steps of generating color image data and generating supplementary image data, and
wherein a second denoising is performed on the color image data and on the supplementary image data after the steps of generating color image data and generating supplementary image data and prior to the step of storing the color image data and the supplementary image data.

15. A method according to claim 14,
wherein, for the denoising performed on the color image data and/or the supplementary image data with respect to high spatial frequencies, information about existing structures, said information contained in low spatial frequencies, is taken into account.

16. A method according to claim 1,
wherein the color image data and the supplementary image data are stored in different data memories.

17. A method according to claim 1,
wherein the sensor image data are generated by an image sensor of a camera, wherein the color image data and the supplementary image data are stored in a data memory of the camera or in a data memory connected to the camera via a local data connection, and wherein only the color image data are additionally stored in a cloud memory via a wide area network or the internet.

18. A method according to claim 1,
wherein the color image data and the supplementary image data comprise metadata that enable a mutual association of image data sets of the color image data and image data sets of the supplementary image data, said image data sets of the color image data and image data sets of the supplementary image data corresponding to a single image data set of the sensor image data.

19. A method according to claim 1,
wherein the color image data and the supplementary image data are stored in encrypted form, wherein the color image data are encrypted with a first key and the supplementary image data are encrypted with a second key different from the first key.

20. A method according to claim 1,
wherein the color image data are converted using the supplementary image data into extended color image data that correspond to a fourth spatial resolution and that comprise at least three color channels, wherein the fourth spatial resolution corresponds to a number of fourth pixels and the extended color image data comprise, for each of the fourth pixels, at least three signal values in accordance with the at least three color channels of the extended color image data, wherein the fourth spatial resolution of the extended color image data is higher than the second spatial resolution of the color image data.

21. A method according to claim 20,
wherein the conversion of the color image data into extended color image data using the supplementary image data comprises the following steps:
determining further signal values of a first color channel of the at least three color channels of the color image data that corresponds to said single color channel of the supplementary image data so that a signal value in accordance with the first color channel of the color image data is present for each of the fourth pixels, wherein these further signal values are determined from the supplementary image data and from signal values of the first color channel of the color image data by transforming spatial frequency values into further signal values or by using the supplementary image data as additional signal values;
determining further signal values of the further color channels of the at least three color channels of the color image data so that signal values in accordance with the further color channels of the color image data are present for each of the fourth pixels, wherein these further signal values are determined from the supplementary image data and from the signal values of the further color channels of the color image data by transforming spatial frequency values into further signal values or by interpolating signal values of the further color channels of the color image data.

22. A method according to claim 20,
wherein the conversion of the color image data into extended color image data using the supplementary image data comprises the following steps:
feeding the color image data and the supplementary image data into a neural network; and
generating the extended color image data by the neural network.

23. A method for processing and storing image data, comprising the steps:
providing sensor image data of an image sensor of a camera, wherein the sensor image data have a first spatial resolution and comprise at least three color channels, wherein the first spatial resolution corresponds to a number of first pixels and the sensor image data comprise, for each of the first pixels, only one signal value from one of the at least three color channels of the sensor image data;
based on the sensor image data, generating color image data that correspond to a second spatial resolution and that comprise at least three color channels, wherein the second spatial resolution corresponds to a number of second pixels and the color image data comprise, for each of the second pixels, at least three signal values in accordance with the at least three color channels of the color image data, wherein the second spatial resolution of the color image data is lower than the first spatial resolution of the sensor image data;
based on the sensor image data, generating supplementary image data that correspond to a third spatial resolution and that comprise only a single color channel, wherein the third spatial resolution corresponds to a number of third pixels and the supplementary image data comprise, for each of the third pixels, only one signal value in accordance with the single color channel of the supplementary image data; and
storing the color image data and the supplementary image data;
wherein the step of generating the color image data based on the sensor image data comprises the following processing steps:
interpolating the sensor image data in order to determine at least two further signal values for each of the first pixels so that a respective signal value is present for each of the first pixels and for each of the at least three color channels of the sensor image data;
for each of the at least three color channels of the sensor image data, transforming the signal values including the interpolated signal values into spatial frequency values that correspond to low and high spatial frequencies; and
determining the color image data for each of the at least three color channels of the color image data by selecting spatial frequency values that correspond to low spatial frequencies; and
wherein the step of generating the supplementary image data based on the sensor image data comprises the following processing step:
determining the supplementary image data for the single color channel of the supplementary image data by selecting spatial frequency values that correspond to high spatial frequencies.

24. A camera system comprising a camera and at least one data memory, wherein the camera has an image sensor for generating sensor image data and a signal processing device for processing the sensor image data, wherein the at least one data memory is connected or can be coupled to the camera, and wherein the signal processing device is configured to carry out the method according to claim 1.
